(19) United States
(12) Patent Application Publication
(10) Pub. No.: US 2005/0227669 A1
(43) Pub. Date: Oct. 13, 2005

(54) Security key management system and method in a mobile communication network

(75) Inventor: Ziv Haparnas, San Francisco, CA (US)

Correspondence Address: FARSHAD JASON FARHADIAN;CENTURY IP LAW GROUP, P.O. BOX 7333, NEWPORT BEACH, CA, 92658-7333, US

(73) Assignee: IXI Mobile (R&D) Ltd.

(21) Appl. No.: 10/820,682

(22) Filed: Apr. 8, 2004

(51) Int. Cl. H04M 1/66

(52) U.S. Cl. 455/410

(57) ABSTRACT

A security system for managing security key assignment in a mobile communications terminal, the security system comprising a key generating mechanism for generating a unique security key for a mobile device, in response to a request received by the security system from the mobile device; a transmission mechanism for transmitting the unique security key to the mobile device; and a data storage mechanism for storing the unique security key for the mobile device in association with an identifier identifying the mobile device, wherein the unique security key is transmitted to a service provider, in response to a request submitted by the service provider to the security system.

### BACKGROUND

### Field of Invention

The present invention relates generally to mobile communication devices and, more particularly, to a system and method for managing security keys assigned to such devices in a mobile communication network.

### Copyright & Trademark Notices

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### Related Art

Most mobile communication devices, such as cellular telephones, are assigned an electronic serial number (ESN) or an international mobile equipment identity (IMEI). The ESN or IMEI are typically stored in the mobile device's nonvolatile memory and are used to uniquely identify the mobile device. The ESN or IMEI is generally burned into the mobile device's memory at the time of manufacturing.

Currently, the ESN/IMEI value (or a value associated with the ESN/IMEI) can be used as a unique identifier to allow a service provider to communicate with a mobile communication network. As such, each service provider will have to depend on the manufacturer for the ESN/IMEI value. Without knowing the ESN/IMEI, a service provider would be unable to establish a line of communication with a mobile device.

Many telephony services (e.g., text messaging, internet access, etc.) in the present communications market are provided by the “voice” service provider (e.g., Sprint, At&T, Vodaphone, etc.). Thus, currently, the service provider that provides the voice related communication services has an agreement with the mobile device manufacturer (e.g., Motorola, Nokia, etc.) wherein the manufacturer exclusively manufactures the mobile devices for the particular service provider.

Accordingly, the manufacturer provides the ESN/IMEI number for each mobile device to each service provider, so that the service provider can set up its server systems to communicate with each mobile device using the ESN/IMEI. The ESN/IMEI value can be used for the purpose of establishing a secure communication line between the mobile device and voice service provider. Unfortunately, however, establishing a secure communication line for application layer downloads and other data services which are not managed by the voice service provider operator is problematic.

Further, as the number of service providers increases and as the type and number of available services diversify, users soon will be able to enter into subscription agreements with more than their voice service provider to satisfy their mobile communication needs. For example, a user may choose Sprint as the voice service provider, AT&T as the text messaging provider, T-Mobile as the long distance provider, Sony as the gaming content provider, CNET as the news content provider, and Microsoft Network as the internet service provider.

As such, a system and method is needed that can provide the means for secured communication lines to be established between various service providers and mobile devices. One can imagine the additional burden on the device manufacturer and each service provider, if each service provider will have to directly rely on the manufacturer to provide it with an ESN/IMEI or a security key for establishing a secured communication line.

Since device manufacturers are not in the business of providing security keys or managing the related infrastructure, a system and method is needed to provide a solution to the above-mentioned problems.

### SUMMARY

A secured communication method for a mobile communications network is provided. The method comprises receiving a request to provide a security key to a mobile device connected to the mobile communications network; generating a unique security key for the requesting mobile device; forwarding the unique security key to the mobile device; receiving a request to provide the unique security key for the mobile device to a service provider; and providing the unique security key to the service provider, if the service provider is approved to receive the unique security key for the mobile device.

The above secured communication method may further comprise denying the request to provide the unique security key, if the service provider is not approved to receive the unique security key for the mobile device and storing the unique security key in the mobile device's data storage mechanism. In one embodiment, the data storage mechanism is a memory chip, an identity module for the mobile device, or a SIM card for the mobile device.

In one embodiment, the unique security key is stored in a data structure in association with a unique value identifying the mobile device. The unique value is the mobile device's electronic serial number (ESN) or international mobile equipment identity (IMEI). A security system determines if the service provider is approved based on content of a list of approved service providers. The list of approved service providers is stored in the mobile device or a security database.

In accordance with one or more embodiments, a security system for managing security key assignment in a mobile communications terminal comprises a key generating mechanism for generating a unique security key for a mobile device, in response to a request received by the security system from the mobile device; a transmission mechanism for transmitting the unique security key to the mobile device; and a data storage mechanism for storing the unique security key for the mobile device in association with an identifier identifying the mobile device.

The unique security key is transmitted to a service provider, in response to a request submitted by the service provider to the security system. A verification mechanism may be included for verifying whether the service provider is an approved service provider before the unique security key is transmitted to the service provider. The service provider is determined to be the approved service provider, if a first condition is met. In some embodiments, the first condition is set by the mobile device and is communicated to the security system by the mobile device.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present, invention are understood by referring to the figures in the attached drawings, as provided below.

FIG. 1 illustrates an exemplary communications environment in accordance with one or more embodiments of the invention;

FIG. 2 is a flow diagram of a method of managing security keys for a mobile device, in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

Electronic systems and corresponding methods, according to an embodiment of the present invention, facilitate and provide a system and method to manage security key assignment for a mobile communication device in a mobile communication network.

In the following, numerous specific details are set forth to provide a thorough description of various embodiments of the invention. Certain embodiments of the invention may be practiced without these specific details or with some variations in detail. In some instances, features of the system are described in less detail so as not to obscure other aspects of the invention. This shall not be construed, however, to mean that such features or aspects take precedent over one another as a matter of importance.

The following detailed description is provided, by way of example, as applicable to a Global System for Mobile Communications (GSM), in accordance with one or more embodiments. The method and system of the present invention may be utilized in application with other mobile communication technologies, however, without departing from the scope of the invention.

GSM is a digital cellular phone technology based on Time Division Multiple Access (TDMA). GSM defines the air interface technology (e.g., TDMA) along with the entire cellular communications network. Presently, GSM enabled mobile devices require the insertion of a Subscriber Identity Module (SIM) in order to perform telephony services. The SIM is a smart card that contains user account information.

User account information may comprise, for example, a communications network's access or configuration data for a particular service provider. Such configuration data includes network access data such as an access point name (APN), a wireless access point internet protocol (WAP IP) address, a web gateway IP address, a short messaging service center (SMSC), system identification code (SID), and other system or environment dependent codes.

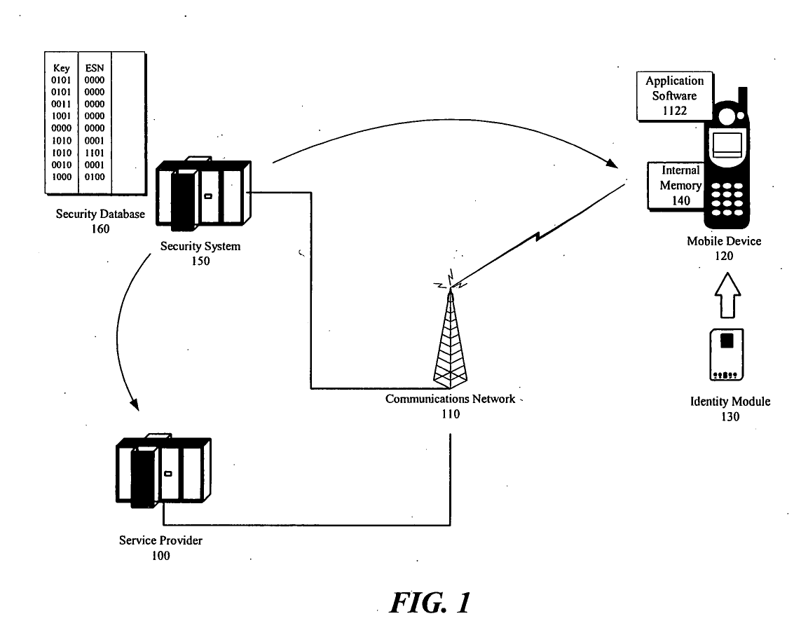

Referring to the drawings, FIG. 1 illustrates an exemplary communications environment in which the system of the present invention may operate. In accordance with one aspect of the system, the environment comprises a service provider 100 connected to a communications network 110. Also depicted are a mobile device 120 configured to receive an identity module (e.g., SIM card) 130, and a security system 150 capable of communicating with service provider 100 and mobile device 120 over communications network 110.

Security system 150 may be connected to, comprise database centers or include storage devices, for example, to update and store, among other information, security and configuration data for establishing a secure connection between service provider 100 and mobile device 120. The terms “connected,” “coupled,” or any variant thereof, mean any connection or coupling, either direct or indirect, between two or more elements. The coupling or connection between the elements can be physical, logical, or a combination thereof.

Communications network 110 comprises the transmission medium and infrastructure for communicating digital or analog signals between service provider 100, mobile device 120 and security system 150. Service provider 100 may be a cellular telephony operator such as, for example, T-Mobile, Orange, Vodaphone or other cellular system operators. Service provider 100 may provide voice communication services for transmitting voice data over communications network 110. In addition to voice, service provider 100 or other service providers connected to communications network 110 may provide other data services, such as text messaging, internet access, gaming, etc.

Communications network 100 may be implemented over any type of mobile, fixed, wired or wireless communication system. For example, one of ordinary skill in the art will appreciate that communications network 100 may advantageously be comprised of one or a combination of various types of networks such as local area networks (LANs), wide area networks (WANs), public, private or secure networks, value-added networks, interactive television networks, wireless communications networks, two-way cable networks, satellite networks, interactive kiosk networks, optical networks, personal mobile gateways (PMGs) and/or any other suitable communications network or segment of the world wide web (i.e., the Internet).

In either context, mobile device 120 can communicate over communications network 100 to send and receive electronic packets of information, in form of electronic requests and responses. Mobile device 120 may be a cellular telephone, a personal digital assistance (PDA), a laptop computer, or any other wired or wireless communication device. In one embodiment, mobile device 120 comprises an internal memory 140. Application software 1122 may be installed and executed on mobile device 120 as client software, for example, to communicate with service provider 100 or security system 150 for the purpose of authenticating and establishing a secured communication link, as provided in further detail below.

In some embodiments, mobile device 120 may comprise a PMG device or communicate with a PMG device. The PMG architecture comprises a PMG server that can wirelessly communicate with a number of PMG enabled devices within the personal area of the user, thus providing a personal area network (PAN).

In addition, the PMG server can wirelessly communicate with remote server systems, such as service provider 100 or security system 150, via a wireless system in a WAN. Thus, the PMG acts as an interface to seamlessly connect a PAN to a WAN, and as such the devices attached to the PAN or WAN can communicate with each other. A more detailed description of the PMG architecture is provided in U.S. patent application Ser. No. 09/850,399, filed on May 7, 2001, the entire content of which is hereby incorporated by reference here.

As used herein, the terms mobile device, service provider, security system and communications network are to be viewed as designations of one or more computing environments that comprise application, client or server software for servicing requests submitted by respective software included in mobile devices or other computing systems connected thereto. These terms are not to be otherwise limiting in any manner. The application software 1122, for example, may be comprised of one or more modules that execute on one or more computing systems, in a self-contained or distributed environment.

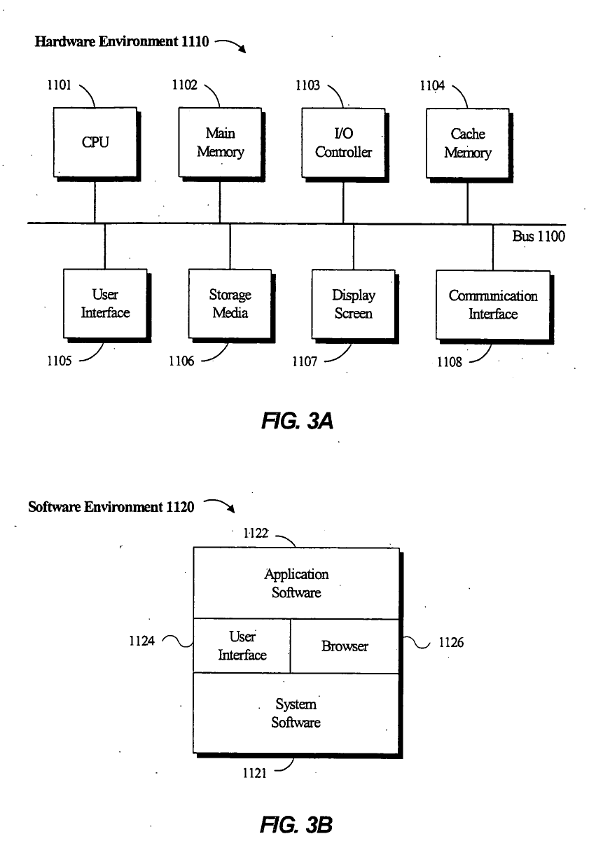

Referring to FIGS. 1, 3A and 3B, in accordance with one aspect of the invention, application software 1122 is implemented on mobile device 120, for example, to cause a request to be transmitted to security system 150 over communications network 110. Based on the request, security system 150 generates a random and unique security key and forwards it to mobile device 120. Security system 150 then stores a copy of the security key in security database 160.

In one or more embodiments, security system 150 stores the security key in database 160 in association with other identifying information that identify mobile device 120. For example, in one embodiment, the security key is stored in association with mobile device 120's electronic serial number (ESN). In another embodiment, the security key is stored in association with mobile device 120's international mobile equipment identity (IMEI). In yet another embodiment, the security key may be stored in association with mobile device 120's phone number.

In a GSM based mobile network, for example, the identifying information may comprise Mobile Subscriber ISDN (MSISDN) for an identity module 130 inserted in mobile device 120. In this later implementation, a security key or a series of classified security keys may be issued based on the identity of an individual user, rather than the device.

Accordingly, when a user subscribes to a new service (e.g., long distance service, internet service, etc.) or when a user purchases a new product (e.g., gaming software, operating system software, etc.) for the mobile device 120 a service provider 100 can request the security key from the security system, instead of having to rely on the manufacturer. After receiving the security key, service provider 100 uses the security key to authenticate with application software 1122 to deliver software updates, deliver telephony data, and/or to provide a variety of other telephony services to mobile device 120.

In some embodiments, application software 1122 may be implemented on a device or system other than mobile device 120. For example, certain components of the application software 1122 may be installed and executed on mobile device 120 while other components may be executed and installed on, for example, a PMG device, communications network 110, service provider 100, security system 150, internet portals, communications server systems, or other computer systems and networks attached thereto.

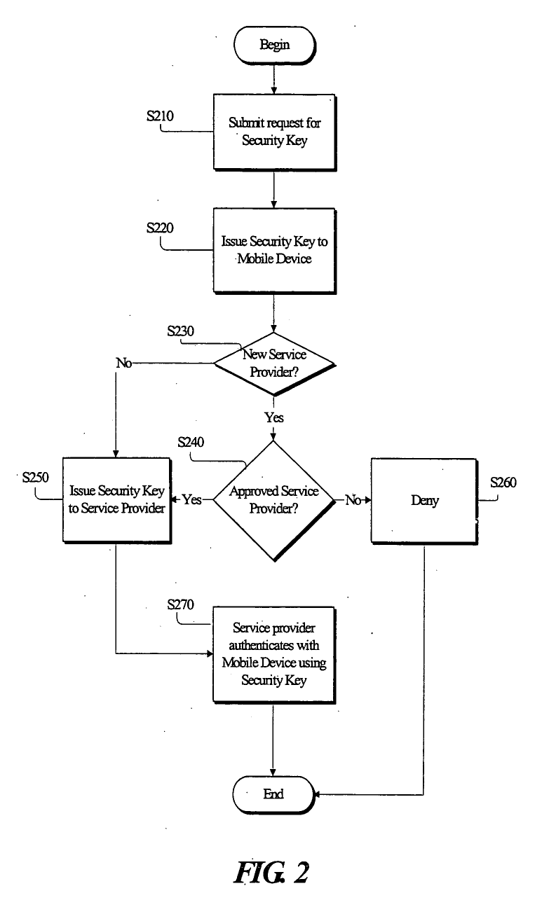

Referring to FIGS. 1 and 2, in accordance with one aspect of the invention, when mobile device 120 is activated for the first time, when a new identity module 130 is inserted or coupled to mobile device 120, application software 1122 recognizes that a security key is not stored in internal memory 140. Without this security key mobile device 120 would not be able to authenticate communications forwarded from certain service providers.

Accordingly, application software 1122 causes mobile device 120 to submit a request for a security key to security system 150, over communications network 110 (S210). The request may be submitted using a wireless communications protocol or preferably by way of a secured text messaging service. In one embodiment, for example, a short text messaging (SMS) protocol may be utilized for delivery of the request to security system 150. This may be accomplished by application software 1122 forwarding a short message to a predetermined address (e.g., telephone number, internet protocol (IP) address, etc.) of security system 150.

The predetermined address may be provided by the manufacturer of mobile device 120 or identity module 130 and may be stored in internal memory 140 or other equivalent storage device. In certain embodiments, configuration data may be stored in other memory storage media or chip that holds its content with or without power (e.g., Electrically Erasable Programmable ROM (EEPROM), Flash Memory, Memory Stick, etc.) of mobile device 120 or identity module 130.

The SMS service, in accordance with one embodiment of the invention, provides a means for establishing a secured communication link between mobile device 120 and security system 150, because eavesdropping on SMS communications is difficult due to security measures built in the SMS protocol. Further, even if the request for the security key is intercepted by a third party, the third party cannot easily reply to the request by generating a unique security code and forwarding it to mobile device 120.

Furthermore, the SMS message that includes the request for the security key is forwarded to the security system 150's predetermined address, preferably, during an initial communication transmission between mobile device 120 and security system 150. In one embodiment, this initial and preferably one-time communication between mobile device 120 and security system 150 is encrypted using a preprogrammed security key stored in mobile device 120 at the time of manufacturing. In other embodiments, a public/private key mechanism may be used.

The initial communication between mobile device 120 and security system 150, in one embodiment, takes place at the time of activation of mobile device 120 or at a time when a new identity module 130 is inserted. Advantageously, the probability of the request being intercepted during this initial (e.g., one-time) communication is very unlikely. One skilled in the art would appreciate that communication protocols or mechanisms other than the SMS may be utilized to establish this initial communication. Therefore, the scope of the invention should not be construed as limited to SMS.

Referring back to FIG. 2, security system 150 responds to the submitted request by issuing a security key to mobile device 120 (S220). In one embodiment, security system 150 uses a random number generator to produce a unique security code. This unique security code is preferably stored in a security database 160 for future reference and is associated with mobile device 120 for the purpose of identification.

In one embodiment, mobile device 120 forwards its ESN/IMEI to security system 150 at the time of submitting the initial request for the security key, for example. Security system 150 then stores the received ESN/IMEI in association with the randomly generated unique security key in database 160, so that the key can be matched to mobile device 120.

Mobile device 120, after receiving the security key issued by security system 150, stores the security key in internal memory 140, for example. A service provider 100 can thus establishing a secure communication line with mobile device 120 by way successfully authenticating against the security key. The authentication process provides a means by which mobile device 120 and service provider 100 can ensure against a decoy by an unauthorized third party.

According to one embodiment of the invention, service provider 100 may obtain the security key by submitting a request to security system 150 over communications network 110. Security system 150 determines if the request is submitted by a new service provider for mobile device 120 (S230). That is, security system 150 verifies whether the requesting service provider 100 has previously communicated with mobile device 120 and/or if it is identified as an approved service provider for mobile device 120 (S240).

Security system 150 or service provider 100 may, for example, be implemented to include a list of approved service providers for mobile device 120, based on information communicated to it by mobile device 120, or by way of contacting mobile device 120 to verify such information. In one embodiment, application software 1122 provides periodic status update information to security system 150 regarding the approved service providers. Alternatively, a list of approved service providers may be stored in internal memory 140, wherein security system 150 can access said list as needed.

If security system 150 determines that a requesting service provider 100 is not an approved provider, then security system 150 denies the requesting service provider access to the security key for mobile device 120 (S260). Otherwise, security system 150 searches security database 160 for a security key that matches mobile device 120 and issues that security key to service provider 100 (S250). In one embodiment, security database 160 is implemented such that the security key for each mobile device 120 is stored in association with mobile device 120's ESN/IMEI. As such, a service provider 100 may request the security key for a mobile device 120 by providing security system 150 with the corresponding ESN/IMEI, for example, or other information (e.g., MSISDN) identifying mobile device 120 or a user of the device.

In one embodiment, different service providers may be provided with different security keys. That is, multiple keys may be associated a mobile device, such that each security key defines a set of privileges for a service provider 100. The user or security system 150 may determine which privileges should be given to a requesting service provider 100. Thus, different service providers are issued security keys in accordance with their approved privileges for a particular mobile device 120.

Once service provider 100 receives the security key for mobile device 120 from security system 150, service provider 100 uses the security key to authenticate with mobile device 120. Advantageously, mobile device 120 can selectively manage and control access by a plurality of service providers with which it prefers to communicate. For example, mobile device 120 may be configured to execute a version of antivirus software (e.g., Symantec Antivirus). By designating a server computer (e.g., symantec.com), for example, as an approved service provider (i.e., a service provider that can securely communicate with mobile device 120), the Norton Server can transmit updated versions of the antivirus software or data to mobile device 120, as needed.

In some embodiments of the invention, the security code and a list of approved service providers are stored in identity module 130. Also stored in the identity module may be a predetermined address (e.g., IP address, phone number, etc.) of security system 150. As such, when identity module 130 is inserted in mobile device 120, a communication connection between mobile device 120 and security system 150 can be established using the predetermined address and the security code.

Once the connection is established, security system 150 accesses information stored in the list of approved service providers and updates the records stored in security database 160, for example, accordingly. As a result, the corresponding approved service providers can authenticate and communicate with mobile device 120. When identity module 130 is removed and another identity module is inserted, the security system 150 updates the records stored in security database 160 based on information stored in the approved service provider's list.

Thus, communication access to mobile device 120 may be controlled by updating security database 160's records to include service providers with which mobile device 120 prefers to communicate. In an alternative embodiment, mobile device 120 may communicate with any service provider 100, unless the service provider 100 has been designated as an unapproved service provider, for example, by being placed in an unapproved list. In other embodiments, security system 150 may determine the approved or unapproved status of a service provider 100 by referring to one or more lists of providers categorized based on different policies or conditions.

In embodiments of the invention, mobile device 120, communications network 110, service provider 100, security system 150, security database 1.60, application software 1122 and identity module 130 comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments of the invention.

Software environment 1120 is divided into two major classes comprising system software 1121 and application software 1122. System software 1121 comprises control programs, such as the operating system (OS) and information management systems that instruct the hardware how to function and process information. Application software 1122 is a program that performs a specific task such as managing secured communication between mobile device 120, security system 150 and service provider 100 based on an assigned security key.

Referring to FIG. 3A, an embodiment of the application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a blue tooth port, a modem, or an integrated services digital network (ISDN) card, etc.), and a system synchronizer (e.g., a clock, not shown in FIG. 3A).

Cache memory 1104 is utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless mobile device (e.g., cellular phone), or other similar hardware platforms that have information processing and/or data storage and communication capabilities. For example, in one or more embodiments of the system, hardware environment 1110 may comprise a PMG unit or an equivalent thereof.

In embodiments of the system, communication interface 1108 can send and receive electrical, electromagnetic, or optical signals that carry digital data streams representing various types of information including program code. If communication is established via a communications network, hardware environment 1110 may transmit program code through the network connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are memory cards, CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems Corporations, for example. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software, such as an operating system that controls the low-level operations of hardware environment 1110. Low-level operations comprise the management of the system resources such as memory allocation, file swapping, and other core computing tasks. In one or more embodiments of the invention, the operating system can be Nucleus, Microsoft Windows CE, Microsoft Windows NT, Macintosh OS, or IBM OS/2. However, any other suitable operating system may be utilized.

Application software 1.122 can comprise one or more computer programs that are executed on top of system software 1121 after being loaded from storage media 1106 into memory 1102. In client-server architecture, application software 1122 may comprise client software and server software. Referring to FIG. 1 for example, in one embodiment of the invention, client software is executed on mobile device 120 and server software is executed on the service provider 100 or security system 150.

Software environment 1120 may also comprise web browser software 1126 for accessing content on a remote server. Further, software environment 1120 may comprise user interface software 1124 (e.g., a Graphical User Interface (GUI)) for receiving user commands and data. The received commands and data are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods that facilitate assigning a security key to a mobile device 120 for secured communication. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but exemplary implementations and are not related, or limited, to any particular computer, apparatus, or computer programming language. Rather, various types of general-purpose computing machines or customized devices may be used with logic code implemented in accordance with the teachings provided, herein. Further, the order in which the methods of the present invention are performed is purely illustrative in nature. These methods can be performed in any order or in parallel, unless indicated otherwise in the present disclosure.

The methods of the present invention may be performed in either hardware, software, or any combination thereof. In particular, some methods may be carried out by software, firmware, or macrocode operating on a computer or computers of any type. Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention. Other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A secured communication method for a mobile communications network, the method comprising:
receiving a request to provide a security key to a mobile device connected to the mobile communications network;
generating a unique security key for the requesting mobile device;
forwarding the unique security key to the mobile device;
receiving a request to provide the unique security key for the mobile device to a service provider; and
providing the unique security key to the service provider, if the service provider is approved to receive the unique security key for the mobile device.

2. The method of claim 1, further comprising:
denying the request to provide the unique security key, if the service provider is not approved to receive the unique security key for the mobile device.

3. The method of claim 1, further comprising:
storing the unique security key in the mobile device's data storage mechanism.

4. The method of claim 3, wherein the data storage mechanism is a memory chip.

5. The method of claim 3, wherein the data storage mechanism is an identity module for the mobile device.

6. The method of claim 3, wherein the data storage mechanism is a SIM card for the mobile device.

7. The method of claim 1, further comprising:
storing the unique security key in a data structure in association with a unique value identifying the mobile device.

8. The method of claim 7, wherein the unique value is at least one of the mobile device's electronic serial number (ESN), international mobile equipment identity (IMEI) and phone number.

9. The method of claim 1, further comprising:
determining if the service provider is approved based on content of a list of approved service providers.

10. The method of claim 9, wherein the list of approved service providers is stored in the mobile device.

11. A security system for managing security key assignment in a mobile communications temminal, the security system comprising:
a key generating mechanism for generating a unique security key for a mobile device, in response to a request received by the security system from the mobile device;
a transmission mechanism for transmitting the unique security key to the mobile device; and
a data storage mechanism for storing the unique security key for the mobile device in association with an identifier identifying the mobile device,
wherein the unique security key is transmitted to a service provider, in response to a request submitted by the service provider to the security system.

12. The security system of claim 11, further comprising:
a verification mechanism for verifying whether the service provider is an approved service provider before the unique security key is transmitted to the service provider.

13. The security system of claim 12, wherein the service provider is determined to be the approved service provider, if a first condition is met.

14. The security system of claim 13, wherein the first condition is set by the mobile device.

15. The security system of claim 14, wherein the first condition is communicated to the security system by the mobile device.
